(19) United States
(12) Patent Application Publication
(10) Pub. No.: US 2011/0078303 A1
(43) Pub. Date: Mar. 31, 2011

(54) DYNAMIC LOAD BALANCING AND SCALING OF ALLOCATED CLOUD RESOURCES IN AN ENTERPRISE NETWORK

(75) Inventors: Li Erran LI, Edison, NJ (US); Thomas Woo, Short Hills, NJ (US)

(73) Assignee: Alcatel-Lucent USA Inc., Murray Hill, NJ (US)

(21) Appl. No.: 12/571,271

(22) Filed: Sep. 30, 2009

(51) Int. Cl. G06F 9/50; G06F 15/16; G06F 9/455; G06N 5/02

(52) U.S. Cl. 709/224; 718/104; 718/1; 718/105; 709/226; 706/46

(57) ABSTRACT

Various exemplary embodiments relate to a workload distribution system for an enterprise network extended in to a cloud network and a related method. The enterprise network may include a series of servers in a private enterprise network and a scalable series of servers in a cloud network. The enterprise network may employ one or more load balancers in both a private enterprise network and cloud network that are connected to each series of servers to distribute work amongst the servers in both networks based on criteria such as overall system performance and costs. The enterprise network may also employ one or more controllers to scale the number of cloud servers allocated to the enterprise network based on the system workload and other user-defined criteria, such as revenue generated per work request.

### TECHNICAL FIELD

Various exemplary embodiments disclosed herein relate generally to network communications and Internet architecture.

### BACKGROUND

A cloud computing network is a highly-scalable, dynamic service, which allows cloud computing providers to provide resources over the Internet to customers. The cloud infrastructure provides a layer of abstraction, such that customers do not require knowledge of the specific infrastructure within the cloud that provides the requested resources. Such a service helps consumers avoid capital expenditure on extra hardware for peak usage, as customers can use the extra resources in the cloud for heavy loads, while using the infrastructure already in place in a private enterprise network for everyday use.

Such systems allow scalable deployment of resources, wherein customers create virtual machines, i.e., server instances, to run software of their choice. Customers can create, use, and destroy these virtual machines as needed, with the provider usually charging for the active servers used.

Currently, cloud service providers offer programs, such as infrastructure as a service (IaaS), which use different pricing schemes when charging for use of cloud resources. Users can therefore place less initial investment on an internal network infrastructure for peak usage. This is especially true for high peak-to-average ratio usages, where users can simply rent the use of cloud resources during peak times. Depending on the implementation, however, scaling into the cloud network and seamlessly assigning work to the newly-assigned virtual machines may be complex, especially for applications that require specific locations of its processes.

In view of the foregoing, it would be desirable to dynamically control the loads placed upon servers in the internal and cloud networks. More specifically, it would be desirable to have a controller automatically scale the use of cloud resources based on system demand and balance the assignment of requests among the internal servers and assigned virtual machines in the cloud network. Other desirable aspects will be apparent to those of skill in the art upon reading and understanding the present specification.

### SUMMARY

In light of the present need for dynamically controlling the workloads of servers in a cloud network allocated to a private enterprise network, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a system for managing resources in a cloud network allocated to a private enterprise network comprising: a first series of servers comprising virtual machines in the cloud network allocated to the private enterprise network; a second series of servers comprising computing resources in the private enterprise network; a load balancer in the private enterprise network for distributing work among members in the first and second series of servers based on performance data of the first and second series of servers; and a controller in the private enterprise network comprising a performance monitor for collecting the performance data of the first and second series of servers.

Various exemplary embodiments also relate to a load balancer for managing workloads in an enterprise network comprising: a load balancing module for dispatching work requests among a first series of servers in a cloud network allocated to a private enterprise network and a second series of servers in the private enterprise network; and a monitoring module for tracking performance of servers comprising the enterprise network by collecting performance data from the first and second series of servers.

Various exemplary embodiments may also relate to a controller for managing resources in an enterprise network comprising: a scaling manager for determining what number of servers in a first series of servers in a cloud network allocated to a private enterprise network and a second series of servers in the private enterprise network should be active, the determination based on performance of the first and second series of servers; and an instance manager for adding and removing at least a server from the first series of servers based on the decision of the scaling manager.

Various exemplary embodiments may also relate to a method of sending a work request to a server in an enterprise network comprising: a load balancing module hosted by a load balancer formulating a request decision rule based on criteria specified by a user; the load balancing module choosing a destination server chosen from a server list hosted by the load balancer through the execution of the decision rule; and the load balancing module dispatching the work request to the destination server.

Various exemplary embodiments also relate to a method of adding at least a server to an enterprise network comprising: a controller determining that an application operating within the enterprise network comprising a private enterprise network and an allocated portion of a cloud network is operating below a threshold performance metric; the controller determining a number of servers in the cloud network to add to a series of servers in the cloud network allocated to the private enterprise network that would raise the performance metric of the application above the threshold value; the controller starting at least a new server, adhering to the determined number of servers to be added; the controller checking the series of servers in the cloud network for a choke point; and the controller monitoring the enterprise network to determine whether to add or remove servers from the series of servers in the cloud network.

Various exemplary embodiments may also relate to a method of removing a server from an enterprise network comprising: a controller comparing the workload of the enterprise network comprising a first series of servers in a cloud network allocated to the enterprise network and a second series of servers in private enterprise network to the total throughput of the enterprise network; the controller marking at least a server in the first series of servers for termination when the total system workload is below a threshold value of the total throughput of the enterprise network; and the controller removing the marked server from the first series of servers.

According to the foregoing, various exemplary embodiments dynamically optimize the use of cloud resources. Various exemplary embodiments also dynamically balance the internal loads placed upon servers in the private enterprise network and the loads placed upon resources in a cloud network allocated to the enterprise.

### BRIEF DESCRIPTION OF THE DRAWINGS

In order to facilitate better understanding of various exemplary embodiments, reference is made to the accompanying drawings, wherein:

FIG. 1 is a schematic diagram of an exemplary network for load balancing and automatic scaling between a private enterprise network and a cloud network;

FIG. 2 is a schematic diagram of an alternative network for load balancing and automatic scaling between a private enterprise and a cloud network;

FIG. 3 is a flowchart of an exemplary method of dispatching requests to a server;

FIG. 4 is a flowchart of an exemplary method of scaling up usage of resources in a cloud network; and

FIG. 5 is a flowchart of an exemplary method of scaling down usage of resources in a cloud network.

### DETAILED DESCRIPTION

Referring now to the drawings, in which like numerals refer to like components or steps, there are disclosed broad aspects of various exemplary embodiments.

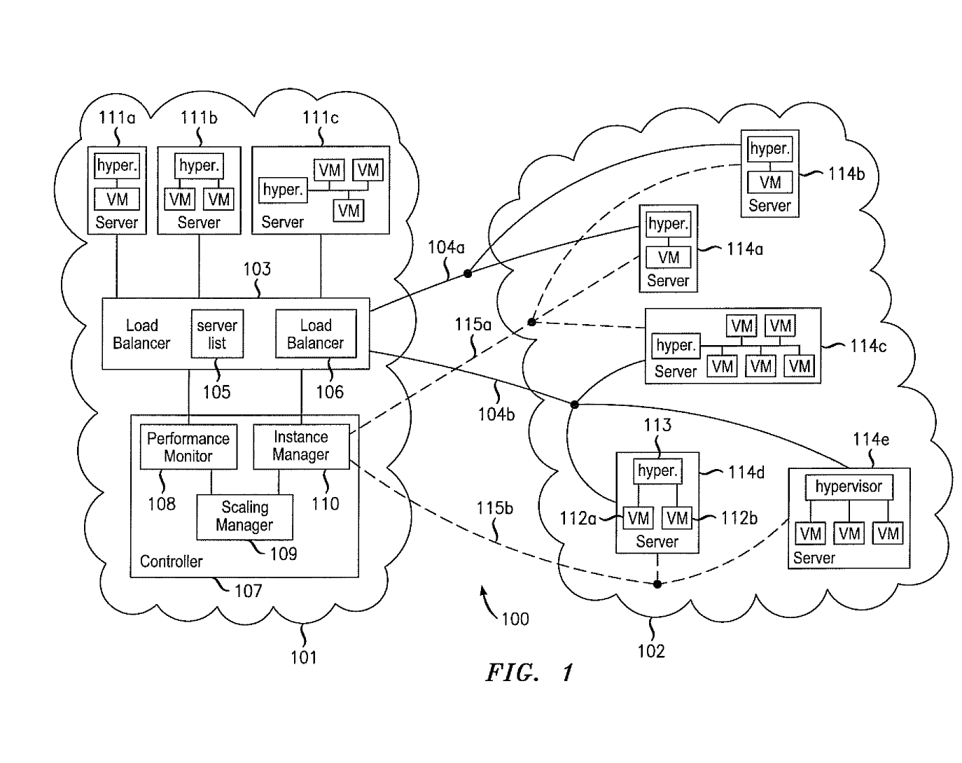

FIG. 1 illustrates an exemplary embodiment of an enterprise-extended network 100 implementing a load balancer 103 and automatic scaler within the enterprise network. The enterprise-extended network 100 may include at least a private enterprise network 101 and a cloud network 103. The private enterprise network 101 may include a load balancer 103, a controller 107, and a series of servers 111a-c. The load balancer 103 may include a server list 105 and a load balancing module 106. The controller 107 may contain a performance monitor 108, a scaling manager 109, and an instance manager 110. The cloud network 102 may include a series of servers 114a-e. Each server in the series of servers 111a-c, 114a-e may contain at least one virtual machine 112a, 112b and a hypervisor 113. The load balancer 103 may connect with each server in the series of cloud servers 114a-e through secure plane connections 104a, 104b. The instance manager 110 may connect to the series of cloud servers 114a-e through secure plane connections 115a, 115b.

As mentioned above, enterprise-extended network 100 may include at least a private enterprise network 101 and a cloud network 102. Although the illustrated environment shows components directly connected, other embodiments may connect private enterprise network 101 and cloud network 102 through a service provider network. Various alternative embodiments may have resources within the private enterprise network 101 (hereinafter referred to as “internal resources”) partitioned over multiple sites and connected through a service provider network. Various alternative embodiments may also have the private enterprise network 101 connect to multiple cloud networks 102 that may not be related to each other.

Private enterprise network 101 may contain a series of servers 111a-c and cloud network 102 may contain a series of “cloud” servers 114a-e. The cloud servers 114a-e may host instances of virtual machines 112a, 112b. A virtual machine 112a may be an instance on a cloud server 114d that is controlled by the customer. A customer may have the ability to create, use, and terminate any number of virtual machines 112a, 112b at will. The virtual machines 112a, 112b allocated to a customer may be connected logically to each other inside cloud network 103.

A hypervisor 113 may host each virtual machine 112a, 112b in the cloud network 103. Each server may host one hypervisor 113 and at least one virtual machine 112a. A hypervisor 113 may therefore host more than one virtual machine 112a, 112b. A hypervisor 113 may manage traffic coming from and directed towards the virtual machines 112a, 112b it manages.

Both sets of servers 111a-c, 114a-e may contain the available computing resources of the enterprise-extended network 100. These computing resources may represent, for example, processing capacity, bandwidth, and storage capacity. Although FIG. 1 illustrates each server in the series 111a-c, 114a-e as being directly connected to each other, alternative embodiments may also have at least some of the servers 111a-c, 114a-e connected through other devices. These devices may include networking devices, such as switches and routers. The series of servers 111a-c in the private enterprise network 101 may be operatively connected to a load balancer 103.

In an illustrative embodiment, load balancer 103 may be a module including hardware and/or machine executable instructions stored on a machine-readable medium. Load balancer 103 may connect with the series of servers 111a-c in the private enterprise network 101 and through secure data plane connections 104a, 104b to the series of servers 114a-e in cloud network 102. Load balancer 103 may contain at least a server list 105 and a load balancing module 106. The server list 105 may be a listing of all servers in the series 111a-c in the private enterprise network 101 and the series 114a-e in the cloud network 102 that are active at any given time.

The load balancing module 106 may distribute work, in the form of requests, among the internal and/or cloud series of servers 111a-c, 114a-e. The load balancing module 106 may use one or more of a number of methods to distribute work, such as, for example, weighted round robin, least connections, or fastest processing. For example, the “weighted round robin” method may use collected performance metrics to assign a weight to each active server 111a-c, 114a-e and distributes work on a rotating basis, while assigning extra work to those servers that can handle higher loads. “Least connections” may use collected performance metrics to choose a server 114a with the least outstanding connections and/or requests, while the “fastest processing” procedure may use collected performance metrics to choose a server 114a with the lowest response time. A request may be, for example, an HTTP request, and may represent the workload of a server 114a once the load balancer 103 forwards the request. All requests may go through the load balancer 103.

As all requests may go through the load balancer 103, the load balancer 103 may also track system performance parameters. These parameters may include, for example, the number of outstanding requests, the average number of completed requests per second, and the response time. The response time may be defined as the time elapsed between when the load balancer 103 receives a request from a client device and when the load balancer 103 receives the last packet of the corresponding response from the server 114a. Alternative response time measurements may also be defined as the time elapsed between when the client device sends out a request and the when the client device receives the last packet of the response from the server 114a.

In the illustrative embodiment of FIG. 1, controller 107 is a module that performs a scaling function separately from load balancer 103. In one embodiment, such separation may prevent overloading a single-threaded load balancer. Controller 107 may contain at least three modules: a performance monitor 108, a scaling manager 109, and an instance manager 110, which may be connected in series within the controller 107. The controller 107 may also register callback functions when a trigger is activated, such as, for example, the response time of a server exceeding a defined threshold.

The performance monitor 108 may be a module including hardware and/or machine executable instructions stored on a machine-readable medium that collects performance data that was forwarded by the load balancer 107 and, in turn, calculates system performance based on the forwarded performance metrics, producing calculated metrics, such as the average number of completed requests per second, response time, etc. The performance monitor 108 may track performance of individual servers 114a-e and VMs 112a, 112b, in addition to tracking network-specific metrics (e.g., internal response time, cloud response time, etc.).

The instance manager 110 may be a module including hardware and/or machine executable instructions stored on a machine-readable medium that manages VM instances 112a, 112b in the series of servers 114a-e located in cloud network 102. The instance manager may be directly connected to the series of servers 114a-e located in cloud network 103. The instance manager may be directly connected to the series of servers 114a-e located in cloud network 103 through a secure control plane connection 115a, 115b. If the instance manager 110 makes any configuration changes to a server 114d in the cloud, such as, for example, initiating a new VM 112b or terminating a server 114b, it may directly update the server list 105 in the load balancer 103.

The scaling manager 109 may be a module including hardware and/or machine executable instructions stored on a machine-readable medium that evaluates whether to adjust the cloud resources being used at any given time. The scaling manager 109 may respond to elastic or inelastic requests. Elastic requests may be defined as requests that do not need to be satisfied within a certain time. In responding to elastic requests, the controller 107 may monitor the number of outstanding requests and use the scaling manager 109 to either scale up or scale down the number of virtual machines 112a, 112b used, based on the number of outstanding requests.

Inelastic requests may be requests that need to be satisfied within a certain time. In responding to inelastic requests, the controller 107, through the scaling manager 109, may use at least one of a multitude of factors, including, for example, the current server load, average response time, and the number of requests having a response time that exceeds a defined threshold. Based on such factors, the scaling manager 109 may decide to scale up the active number of instances when application performance using virtual machines 112a, 112b on the currently active servers 111a-c, 114a-e cannot meet a target value. Alternatively, the scaling procedure may scale down the number of instances when the total system load drops below a target fraction of a threshold.

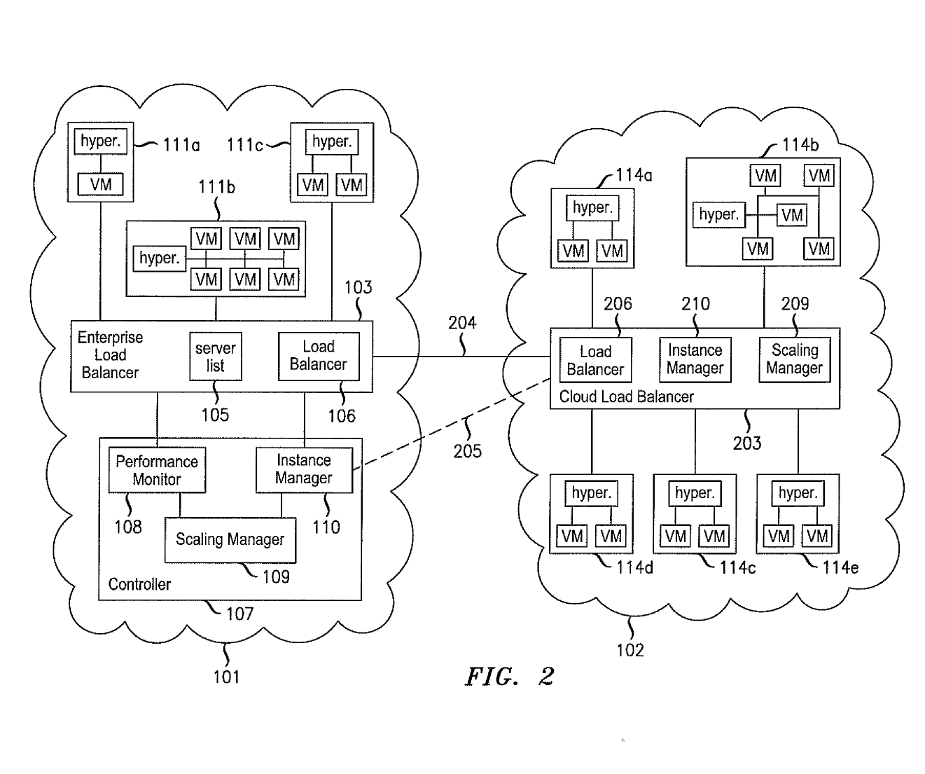

FIG. 2 is an illustrative alternative embodiment of the enterprise-extended system. In this alternative embodiment, there is a second load balancer 203 in the cloud network 102 (the cloud load balancer) in addition to the load balancer 103 in the private enterprise network 101 (the enterprise load balancer). In the illustrated embodiment, the cloud load balancer 203 hosts the load balancer module 206, scaling manager 209, and the instance manager 210.

In the illustrative embodiment, the private enterprise network 101 may also host a controller 107 that may automatically terminate the cloud load balancer 203 when it determines that all VM instances 112a, 112b are not necessary at a given time. The enterprise load balancer 103 may connect with cloud load balancer 203 through a secure plane connection 204. In FIG. 2, the cloud resources of cloud network 102, including the series of servers 114a-c and cloud load balancer 203 appear as a single server to the enterprise load balancer 103. The enterprise load balancer 103 maintains a server list 105 and load balancing module 106, which in the illustrative embodiment, balances the loads of the internal servers 111a-c, while cloud load balancer 203 may balance the loads of the VMs 112a, 112b hosted on the cloud servers 114a-e.

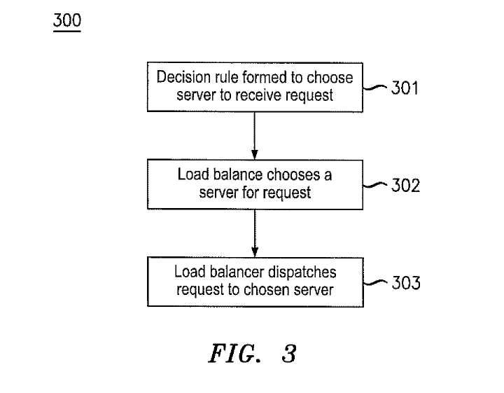

FIG. 3 is a flowchart of an exemplary method 300 of dispatching requests to a server. In various exemplary embodiments, the processing of FIG. 3 may be executed by the load balancing module 106. Other suitable components for execution of method 300 will be apparent to those of skill in the art.

In step 301, a set of criteria may be used by the load balancing module 106 to formulate a rule for decision-making. Such criteria may include the above-discussed performance metrics, such as, for example, the average number of completed requests by a server 114b per second and a response time for server 114b, both for servers 111a-c in the enterprise network 101 (internal) and servers 114a-e in the cloud network 102 (cloud). Other criteria for a decision may include internal costs, which may be derived from energy usage and/or internal server load. Criteria for a decision may also include cloud costs, which may be derived from fees imposed by the cloud service provider. These fees imposed by the cloud service provider may be derived from bandwidth, processor, and storage usage and the active time connected.

From this, a customer may formulate rules for a load balancing module 106 to decide which network server 111a-c, 114a-e should receive the request. In some embodiments, a customer may formulate rules for a load balancing module 106 to decide which specific server 111a or virtual machine 112a should receive the request. As an example, a customer may decide to base decisions on a preference to always send requests to an internal server 111a until the servers 111a-c can no longer handle the load, such as when the internal response time exceeds a defined threshold. Other rules may also include overall system performance (choose a server in the network with the smallest relative response time), system performance per dollar (choose a server in the network with the response time divided by the cost that is the lowest), and revenue generated per request (choose a server in the network with the largest net generation of revenue per request serviced).

In step 302, the load balancing module 106 uses a load balancing function to determine which specific server 111a-c, 114a-e should receive the request. Continuing with the example, if a customer uses a decision rule that dictates that requests should always use internal resources when available, the load balancing module 106 will refer to this rule and send an incoming request to an internal server 111a until it reaches a threshold that may indicate overload or suboptimal system performance.

In step 303, the load balancing module 106, based on the decision determined in step 302, dispatches the request to a server 111a-c, 114a-e in the determined network 101, 102. For example, if the decision rule determines that an internal server 111a-c should handle the request, the load balancing module 106 may then dispatch the request to a server 111a in private enterprise network 101. Load balancing module 106 may use a load balancing method to distribute work among the servers 111a-c within a particular network 101. The load balancing module 106 may use at least one or a combination of a number of distribution methods such as, for example, weighted round robin, least connections, and fastest processing, as described above.

As an example of method 300, a load balancing module 106 may incorporate a decision rule of using internal servers 111a-c first and a load balancing method of fastest processing. The load balancing module 106 first receives criteria to create a decision-making rule from a user. The decision rule may be to use an internal server until reaching the threshold, such that the load balancing module 106 will only send requests to a cloud server 114a-e when response time equals the threshold.

After the load balancing module 106 sets the decision rule, the load balancing module 106, upon receiving the request, refers to the decision rule to choose a specific server among internal servers 111a-c and cloud servers 114a-e, to receive the request. In the current example, the response time exceeds the threshold, so the decision rule determines that the load balancing module 106 should forward the request to a cloud server 114a-e. The load balancing module 106 may thereafter use the load balancing method of “fastest processing” to decide which server 114a-e in the cloud network 102 should receive the request. The “fastest processing” load balancing method uses performance data collected by the performance monitor 108 to determine that the cloud server 114d will respond to the request with the least response time. The load balancing module 106 therefore forwards the request to the cloud server 114d.

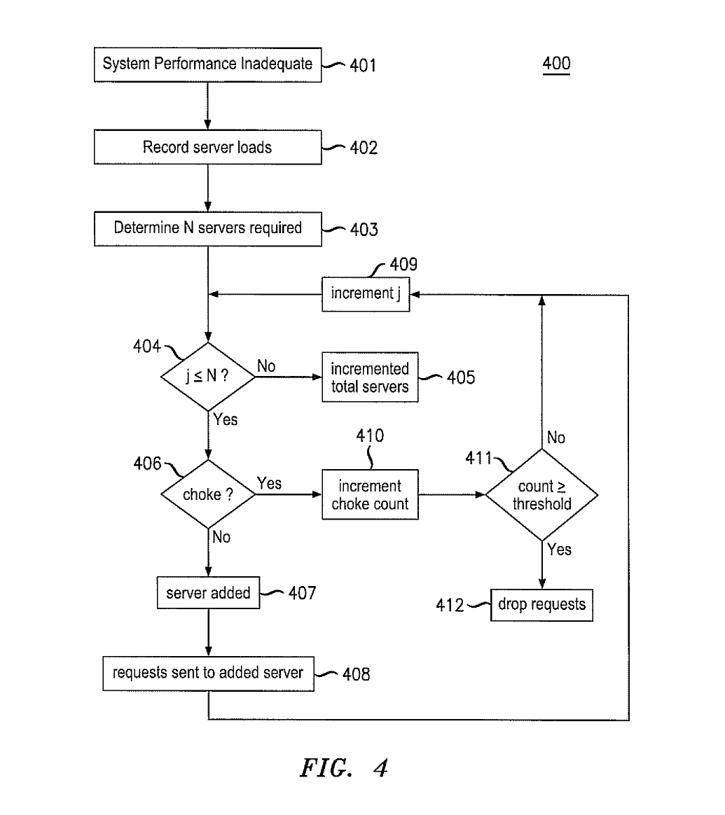

FIG. 4 is a flowchart of an exemplary method 400 of scaling up the enterprise-extended network by adding at least one server. In various exemplary embodiments, the processing of FIG. 4 may be executed by various components inside the controller 107. Other suitable components for execution of method 400 will be apparent to those of skill in the art. The decision to scale up may occur when application performance within the enterprise network 100 does not meet a pre-determined target.

The target may be a performance target, such as the number (or fraction) of requests whose response times exceed a time threshold. Another target may be, for example, the average response time or the server load exceeding a defined threshold, where the average response time may be measured as the number of requests processed per second averaged over time. When these target quantifications reach a specific threshold value, step 401 may occur, whereupon scaling manager 109 may deem the performance inadequate. For example, the scaling manager 109 may only decide to scale up when the average response time (exponential moving average) of the entire system exceeds a threshold, or when the percentage of excessive response times exceeds a defined threshold number.

In step 402, the performance monitor 108 records the load on each server currently active before any new server 111a-c, 114a-e is added to the system. This recording may be used by the instance manager 110 at another time to eliminate extraneous servers 111a-c, 114a-e while scaling down the enterprise network, as will be described in further detail below.

In step 403, the scaling manager 110 may estimate the number (N) of extra servers needed. The new servers 111b, 111c may come from the private enterprise network 101 or cloud network 102. The scaling manager 109 may estimate the number of servers 111a-c, 114a-e needed by dividing the amount of additional throughput required by the average throughput (T*_{avg}) of the virtual machines (VMs) 112a, 112b on the servers 114a, 114b in use in the cloud network 102. A server's throughput is the maximum load the server may handle while maintaining a response time below the threshold Tₕ. T*_{avg} may equal the sum of the throughputs of the active cloud servers 114a, 114b divided by the number of cloud servers currently active.

In step 404, the scaling manager 109 may begin a loop that executes N times, where N is the number of additional servers required. Thus, to begin this processing, scaling manager 109 may initialize a variable j to 1. In step 404, scaling manager 109 may first determine if j is less than or equal to the number of servers required, N. When j is greater than N, step 405 ensues, where the scaling manager 109 may increment the total number of servers by N.

Alternatively, when j is less than or equal to N, step 406 may follow. In step 406, the instance manager 110 may attempt to determine whether the jth virtual machine to be added is a choke point. A choke point may be a server experiencing a bottleneck or a component or grouping of components limiting the performance (e.g., application processing) or capacity of the entire network. In order to determine whether the new server is a choke point within the enterprise network, the load balancer may send a small set of requests to the new server 114d. The load balancer 103 then monitors the response time of the server 114d.

When the response time from the new server is greater than or equal to the average minimum response time of the virtual machines 116a-d currently in use, the scaling manager 109 may determine that adding the new server would provide little benefit. The scaling manager 109 may also make this determination when the total throughput of the system does not increase in response to addition of the new server, or if the increase in throughput is substantially lower than T*_{avg}. In each of these circumstances, the scaling manager 109 may determine that there is a choking point related to the new server (either in the server itself or in other parts of the system).

If, at step 406, the new load placed upon the prospective new server 114d causes it to become a choke point, in step 410, the choke_vm counter is increased and the server is not added. When the choke_vm counter exceeds a pre-determined threshold, at step 411, the scaling manager 109 determines that the enterprise network is choking and in step 412, the instance manager 110 signals the load balancer 103 to drop requests until it reaches a point where the system can again handle the system load. Otherwise, when the scaling manager 109 determines in step 411 that the choke threshold was not exceeded, the scaling manager increments j by one in step 409 and returns to step 404.

The choke_vm counter, as described in step 410, may thereby enable scaling up when only a subset of servers are unresponsive. In other words, maintaining a counter tracking the number of VMs that are choking may prevent the controller 107 from labeling the entire system as choking based merely upon the behavior of a single VM 112b.

Returning to step 406, in instances where no choke point is detected, the method proceeds to step 407, where the instance manager 110 may add a new server 114d. Alternatively, if the particular server being tested was previously marked for deletion (based, for example, on a scaling down operation), instance manager 110 may reactive the server. In step 408, the load balancer 103 forwards the new server 114d T*_{avg} requests per second. Method 400 then proceeds to follow the loop to step 409 by incrementing j by one and returning to step 404 to determine whether additional servers require processing.

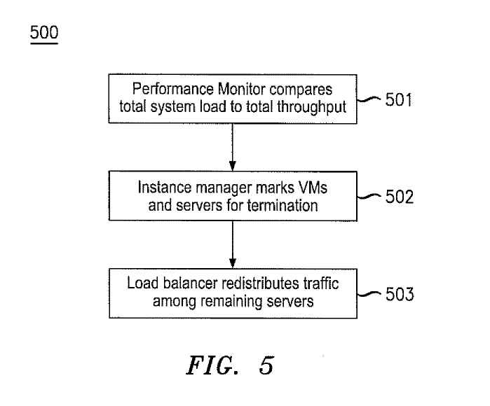

FIG. 5 is a flowchart of an exemplary method 500 of scaling down the enterprise network. In various exemplary embodiments, the processing of FIG. 3 may be executed by various components inside controller 107. Other suitable components for execution of method 300 will be apparent to those of skill in the art.

In step 501, performance monitor 108 compares the total system load to the total throughput

$$( {\sum }_{j = 1}^{K} {T}_{j , k}^{*} ) ,$$

which may be the sum of the throughput of each active server 111a-c, 114a-e. If the total load is below a threshold value, such as when 98% of the response times are below the threshold value, then at step 502, a server 114d or VM 112b may be marked for termination by the instance manager 110. More than one VM 112a, 112b or server 114d, 114e may be marked by instance manager 110 for termination at a given time.

The instance manager 110 may wait for all outstanding processes at the marked device to finish before shutting down a VM 112b or server 114d. The instance manager 110 may use pre-determined criteria when making its selection. For example, if a cloud service provider charges VM usage by the hour, a user may set criteria for the instance manager 110 to select the VM 112b with the highest probability to finish its load within the remaining time of the hour.

In step 503, the load balancing module 106 redistributes traffic among the remaining active servers. The load balancing module 106 may use performance metrics, such as current server load, average response time, and the number of requests having a response time that exceeds a defined threshold, and load balancing methods, such as weighted round-robin, least connections, and fastest processing, to balance the remaining load among the remaining servers 111a-c, 114a-e in the internal network 101 and cloud network 102.

According to the foregoing, various exemplary embodiments provide for dynamic and seamless load balancing of requests between servers in an enterprise-extended network. Such load balancing, while effectively using both servers in a private enterprise network and servers in a cloud network, may also optimize use of cloud networks servers based on a multitude of factors, including the cost of using the servers. In conjunction with the effective use of cloud servers, the embodiments also provide for a dynamic auto-scaler, which provides dynamic addition and termination of virtual machines in the cloud network based on the increased or decreased needs of the system. The load balancer and auto-scaler allow users to consume cloud resources efficiently, both in terms of performance and in terms of cost.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine. Thus, a machine-readable storage medium may include read-only memory (ROM), random-access memory (RAM), magnetic disk storage media, optical storage media, flash-memory devices, and similar storage media.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A system for managing resources in a cloud network allocated to a private enterprise network, the system comprising:
a first series of servers comprising virtual machines in the cloud network allocated to the private enterprise network;
a second series of servers comprising computing resources in the private enterprise network;
a load balancer in the private enterprise network for distributing work among members in the first and second series of servers based on performance data of the first and second series of servers; and
a controller in the private enterprise network comprising a performance monitor for collecting the performance data of the first and second series of servers.

2. The system of claim 1, further comprising:
a second load balancer in the cloud network for distributing work among members of the first series of servers, wherein the first load balancer in the private enterprise network identifies and distributes work to the second load balancer as a single server in the cloud network.

3. The system of claim 1, the controller further comprising:
a scaling manager for deciding when to add or remove servers from the first series of servers, wherein the decision by the scaling manager is based upon user-specified criteria; and
an instance manager for adding and removing servers from the first series of servers based on the decision of the scaling manager.

4. A load balancer for managing workloads in an enterprise network, the load balancer comprising:
a load balancing module for dispatching work requests among a first series of servers in a cloud network allocated to a private enterprise network and a second series of servers in the private enterprise network; and
a monitoring module for tracking performance of servers comprising the enterprise network by collecting performance data from the first and second series of servers.

5. The load balancer of claim 4, further comprising:
a server list comprising entries for each server in the first series and second series of servers.

6. The load balancer of claim 4, wherein the load balancer connects to the first series of servers through at least a data plane connection.

7. The load balancer of claim 4, wherein the load balancing module, in dispatching requests, uses an procedure consisting of at least one member of the group of:
a first procedure comprising the load balancing module choosing a destination server with the least outstanding connections or requests;
a second procedure comprising the load balancing module choosing a destination server that has the smallest response time; and
a third procedure comprising load the balancing module choosing a destination server based on a weighted round-robin allocation method.

8. A controller for managing resources in an enterprise network, the controller comprising:
a scaling manager for determining a number of servers in a first series of servers in a cloud network allocated to a private enterprise network and in a second series of servers in the private enterprise network that should be active, the determination based on performance of the first and second series of servers; and
an instance manager for adding or removing at least a server from the first series of servers based on the decision of the scaling manager.

9. The controller of claim 8, further comprising:
a performance monitor for collecting performance data of the first and second series of servers and providing calculated performance metrics based on the collected performance data to the scaling manager.

10. The controller of claim 8, wherein the instance manager connects to the first series of servers through at least a control plane connection.

11. A method of sending a work request to a server in an enterprise network, the method comprising:
formulating, by a load balancing module hosted by a load balancer, a request decision rule based on criteria specified by a user;
choosing, by the load balancing module, a destination server, the destination server chosen from a server list hosted by the load balancer through the execution of the decision rule by the load balancing module; and
dispatching, by the load balancing module, the work request to the destination server.

12. The method of claim 11, wherein the user-specified criteria comprises a system performance metric consisting of a least one member of the group of:
average number of completed requests per second;
response time;
energy usage;
server load;
bandwidth costs;
processing costs;
storage usage costs; and
active time connected.

13. The method of claim 11, wherein the request decision rule uses a method consisting of at least one member of the group of:
a first rule comprising a preference to always send a request to a server in a private enterprise network before sending a request to a server in a cloud network allocated to the private enterprise network;
a second rule comprising choosing a server that would maximize performance in the enterprise network;
a third rule comprising choosing a server that would maximize performance in the enterprise network per dollar spent; and
a fourth rule comprising choosing a server that would maximize revenue generated.

14. A method of adding at least a server to an enterprise network, the method comprising:
determining, by a controller, that an application operating within the enterprise network comprising a private enterprise network and an allocated portion of a cloud network is operating below a threshold performance metric;
determining, by the controller, a number of servers in the cloud network to add to a series of servers in the cloud network allocated to the private enterprise network that would raise the performance metric of the application above the threshold value;
starting, by the controller, at least one new server, the controller determining the number of servers to be started;
checking, by the controller, the series of servers in the cloud network for a choke point; and
monitoring, by the controller, the enterprise network to determine whether to add or remove servers from the series of servers in the cloud network.

15. The method of claim 14, the checking step further comprising:
sending, by a load balancer module, a first set of requests to the server added by the controller;
removing, by the controller, the added server when the response time of the added server is substantially similar to the average response time of the enterprise network;
sending, by the load balancer module, a second set of requests to the added server;
increasing, by the controller, a value on a choke counter recording the number of choke events when the second set of requests causes the added server to choke; and
removing, by the controller, the added server when the choke counter passes a threshold value.

16. The method of 14, wherein the load balancer module sends the second set of requests at a rate equal to the average throughput of the enterprise network.

17. A method of removing a server from an enterprise network, the method comprising:
comparing, by a controller, the workload of the enterprise network, the enterprise network comprising a first series of servers in a cloud network allocated to the enterprise network and a second series of servers in private enterprise network to the total throughput of the enterprise network;
marking, by the controller, at least a server in the first series of servers for termination when the total system workload is below a threshold value of the total throughput of the enterprise network; and
removing, by the controller, the marked server from the first series of servers.

18. The method of claim 17, further comprising:
dispatching, by a load balancer module, a series of work requests amongst the first and second series of servers that were not terminated by the controller.
